(19) United States
(12) Patent Application Publication
(10) Pub. No.: US 2021/0343461 A1
(43) Pub. Date: Nov. 4, 2021

(54) ELECTROMAGNETIC ACTUATOR

(71) Applicant: DENSO CORPORATION, Kariya-city (JP)

(72) Inventor: Hitoshi AMANO, Kariya-city (JP)

(21) Appl. No.: 17/240,137

(22) Filed: Apr. 26, 2021

(30) Foreign Application Priority Data
Apr. 30, 2020 (JP) 2020-080192

(51) Int. Cl. H01F 7/08; H01F 7/16; F16K 31/06

(52) U.S. Cl. CPC H01F 7/081; H01F 7/16; F01L 9/21; H01F 2007/086; F16K 31/0675

(57) ABSTRACT

A mover is attracted and is moved in an axial direction with a predetermined stroke by a magnetic force generated between a stator and the mover when a coil is energized. The stator includes: a first stator positioned at a side where a stroke start position of the mover is located, and a second stator positioned at another side where a stroke end position of the mover is located. The mover includes a tapered portion which has a diameter progressively reduced toward the second stator, and a small-diameter cylindrical portion which is shaped in a straight form and has a constant outer diameter along an entire axial extent of the small-diameter cylindrical portion. An outer wall of the small diameter cylindrical portion has the outer diameter that is equal to an outer diameter of a smallest-diameter part of the tapered portion.

### CROSS REFERENCE TO RELATED APPLICATION

This application is based on and incorporates herein by reference Japanese Patent Application No. 2020-080192 filed on Apr. 30, 2020.

### TECHNICAL FIELD

The present disclosure relates to an electromagnetic actuator that is configured to attract and move a mover in an axial direction by a magnetic force generated between a stator and the mover.

### BACKGROUND

Previously, there is known an electromagnetic actuator that has two stators arranged side by side in an axial direction between a coil and a mover. For example, in one previously proposed electromagnetic actuator, the first stator is positioned at a side where a stroke start position of the mover is located, and the second stator is positioned at another side where a stroke end position of the mover is located. The mover has a tapered portion that has an outer diameter which is progressively reduced toward the second stator. In response to movement of the mover toward the stroke end position, a width of a gap between the mover and the first stator is changed by the tapered portion such that an attractive force for attracting the mover during the stroke of the mover is substantially leveled.

### SUMMARY

This section provides a general summary of the disclosure, and is not a comprehensive disclosure of its full scope or all of its features.

According to one aspect of the present disclosure, there is provided an electromagnetic actuator that includes a coil, a stator, and a mover. The mover is configured to be attracted and moved in an axial direction with a predetermined stroke by a magnetic force generated between the stator and the mover when the coil is energized. The stator includes a first stator and a second stator. The first stator is positioned at a side where a stroke start position of the mover is located. The second stator is positioned at another side where a stroke end position of the mover is located. The mover includes a tapered portion and a straight portion. The tapered portion has a diameter progressively reduced toward the second stator. The straight portion extends continuously from the tapered portion toward the second stator.

### BRIEF DESCRIPTION OF DRAWINGS

The drawings described herein are for illustrative purposes only of selected embodiments and not all possible implementations, and are not intended to limit the scope of the present disclosure.

FIG. 1 is a cross-sectional view showing an electromagnetic actuator according to a first embodiment of the present disclosure.

FIG. 2 is a cross-sectional view of the electromagnetic actuator of FIG. 1 showing a state in which a mover is moved to a stroke end position.

FIG. 3 is an enlarged cross-sectional view of an area III in FIG. 1.

FIG. 4 is an enlarged cross-sectional view of an area IV in FIG. 2.

FIG. 5 is a graph showing attraction characteristics of the electromagnetic actuator shown in FIGS. 1 and 2.

FIG. 6 is a partial cross-sectional view showing an electromagnetic actuator of a comparative example.

FIG. 7 is a cross-sectional view showing an electromagnetic actuator according to a second embodiment of the present disclosure.

### DETAILED DESCRIPTION

Previously, there is known an electromagnetic actuator that has two stators arranged side by side in an axial direction between a coil and a mover. For example, in one previously proposed electromagnetic actuator, the first stator is positioned at a side where a stroke start position of the mover is located, and the second stator is positioned at another side where a stroke end position of the mover is located. The mover has a tapered portion that has an outer diameter which is progressively reduced toward the second stator. In response to movement of the mover toward the stroke end position, a width of a gap between the mover and the first stator is changed by the tapered portion such that an attractive force for attracting the mover during the stroke of the mover is substantially leveled.

However, in the previously proposed electromagnetic actuator, the tapered portion of the mover has the outer diameter which is progressively reduced toward the second stator. Therefore, when the mover is in the stroke start position, the gap between the mover and the second stator is disadvantageously widened by the tapered portion. Thus, the attractive force at the start initial time of the electromagnetic actuator is reduced, and it is difficult to obtain flat attraction characteristics over an entire stroke length of the mover.

According to one aspect of the present disclosure, there is provided an electromagnetic actuator that includes a coil, a stator, and a mover. The mover is configured to be attracted and moved in an axial direction with a predetermined stroke by a magnetic force generated between the stator and the mover when the coil is energized. The stator includes a first stator and a second stator. The first stator is positioned at a side where a stroke start position of the mover is located. The second stator is positioned at another side where a stroke end position of the mover is located. The mover includes a tapered portion and a straight portion. The tapered portion has a diameter progressively reduced toward the second stator. The straight portion extends continuously from the tapered portion toward the second stator. An outer wall of the straight portion, which extends in the axial direction, has an outer diameter that is substantially equal to an outer diameter of a smallest-diameter part of the tapered portion that has a smallest diameter at the tapered portion. Here, the substantially equal outer diameters of the straight portion and the smallest-diameter part refer to that the outer diameter of the straight portion and the outer diameter of the smallest-diameter part are substantially the same. That is, even if there is a minute discrepancy in the outer diameters due to, for example, a machining error, the outer diameters are regarded as substantially equal to each other.

With the electromagnetic actuator of the present disclosure, when the mover is in the stroke start position, the tapered portion approaches the second stator. However, since the straight portion extends continuously from the smallest-diameter part of the tapered portion toward the second stator, the gap between the mover and the second stator is not disadvantageously widened at the stroke start position. Therefore, the reduction in the attractive force at the start initial period of the electromagnetic actuator can be limited, and the flat attraction characteristics can be obtained over the entire stroke length.

Hereinafter, embodiments of the present disclosure will be described with reference to the drawings.

### First Embodiment

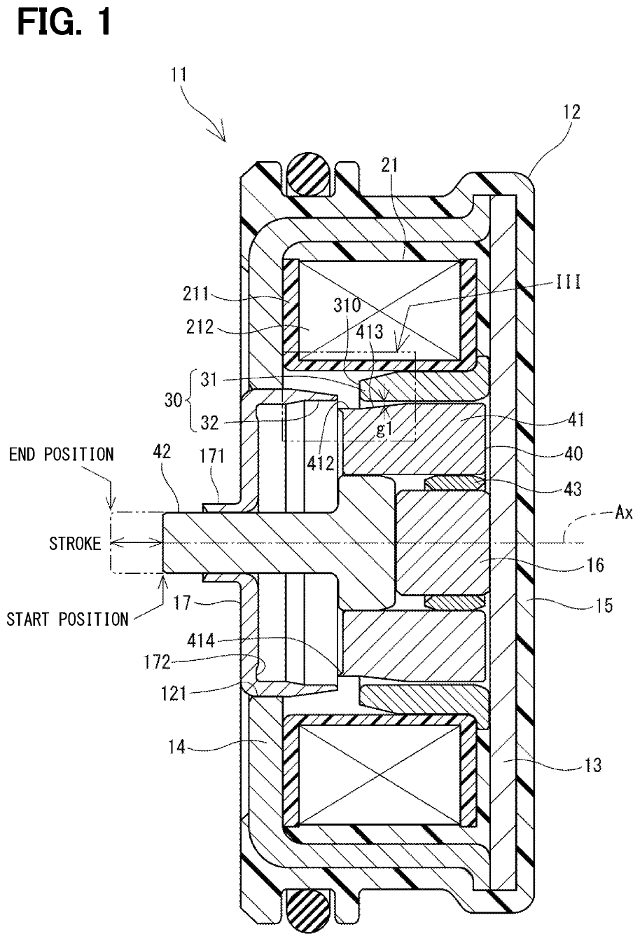

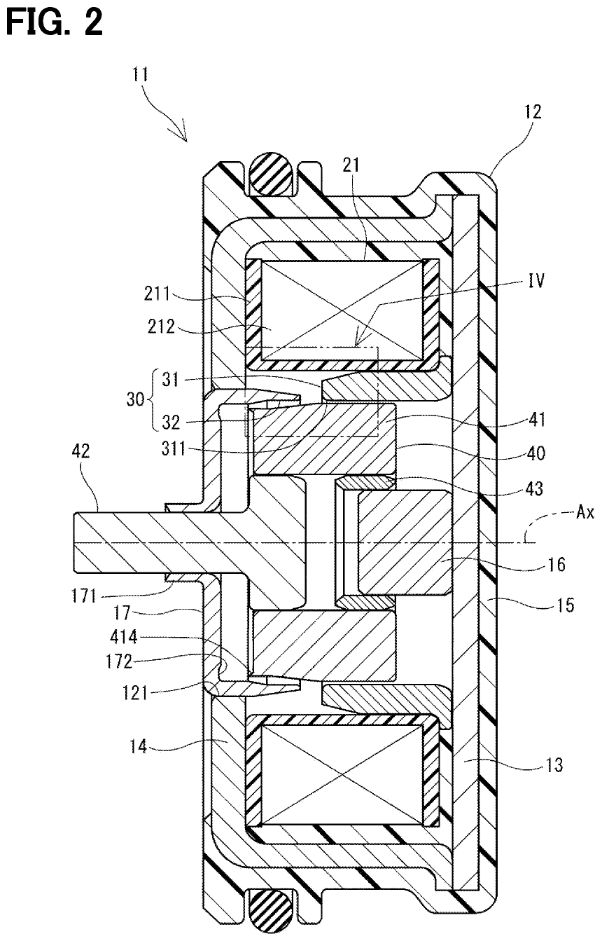

A first embodiment of the present disclosure will be described with reference to the drawings. An electromagnetic actuator 11 shown in FIGS. 1 and 2 is used as a linear solenoid in a valve timing adjusting mechanism of an internal combustion engine for a vehicle.

A housing 12 of the electromagnetic actuator 11 includes: a base 13 which is made of a magnetic material; a case 14 which is made of a magnetic material; and a dielectric film (also referred to as a dielectric cover) 15 which is made of resin and entirely covers the base 13 and the case 14. A coil 21 is placed at an inside of the case 14 and is fixed to the housing 12 by a portion of the dielectric film 15. The coil 21 is shaped in a circular ring form as a whole and includes: a bobbin 211 which is made of resin; and a winding arrangement (arrangement of windings) 212.

A stator 30 is placed on an inner side of the coil 21, and a mover 40 is placed on an inner side of the stator 30. The mover 40 is attracted and is moved in an axial direction of the electromagnetic actuator 11 (i.e., an axial direction of an axis Ax shown in FIG. 1) with a predetermined stroke by a magnetic force generated between the stator 30 and the mover 40 when the coil 21 is energized.

The stator 30 includes: a first stator 31 positioned at a side where a stroke start position of the mover 40 is located, and a second stator 32 positioned at another side where a stroke end position of the mover 40 is located. The first stator 31 is formed into a cylindrical form by cold forging of a magnetic material, and is fixed to the base 13 at a base end of the first stator 31. The second stator 32 is formed by a cylindrical portion of a cover member 17 made of a magnetic material, and the cover member 17 is fixed to the case 14 such that the cover member 17 closes a front opening 121 of the housing 12.

The mover 40 includes: a cylinder 41 which is made of a magnetic material and is sintered by a sintering process; a plunger 42 which is an output shaft of the electromagnetic actuator 11; and a slider 43. The cylinder 41, the plunger 42 and the slider 43 are assembled together and are thereby movable integrally. The cylinder 41 is placed on an inner side of the first and second stators 31, 32 while a gap is interposed between the cylinder 41 and the first and second stators 31, 32. The plunger 42 is arranged on the axis Ax of the electromagnetic actuator 11 in a state where a base of the plunger 42 is fixed to an inner periphery of a distal end portion of the cylinder 41.

The slider 43 is made of a low-friction material and is shaped in a circular ring form. The slider 43 is fixed to an inner periphery of a base end portion of the cylinder 41. A guide member 16, which also functions as a stopper for the plunger 42, is fixed to the base 13. The slider 43 is slidably fitted to the guide member 16. Furthermore, a boss portion 171, through which the plunger 42 is slidably inserted, is formed at a center of the cover member 17. Movement of the mover 40 is guided by the guide member 16 and the cover member 17.

The first stator 31 and the second stator 32 are placed on the inner side of the coil 21 such that the first stator 31 and the second stator 32 are arranged side by side in a moving direction of the mover 40. When the coil 21 is energized, the mover 40 is attracted and is moved from a start to an end of the stroke of the mover 40 by the magnetic force generated between the cylinder 41 of the mover 40 and the first stator 31 and the magnetic force generated between the cylinder 41 of the mover 40 and second stator 32. FIG. 1 indicates a stroke start position of the mover 40, and FIG. 2 indicates a stroke end position of the mover 40.

The stroke end position is not limited to the position shown in FIG. 2 and may be set further forward (on the cover member 17 side) than the position shown in FIG. 2 depending on an intended application of the electromagnetic actuator 11. Furthermore, when the energization of the coil 21 is stopped, the mover 40 is returned from the end position to the start position by a spring member provided in a driven-side device (e.g., the valve timing adjusting mechanism).

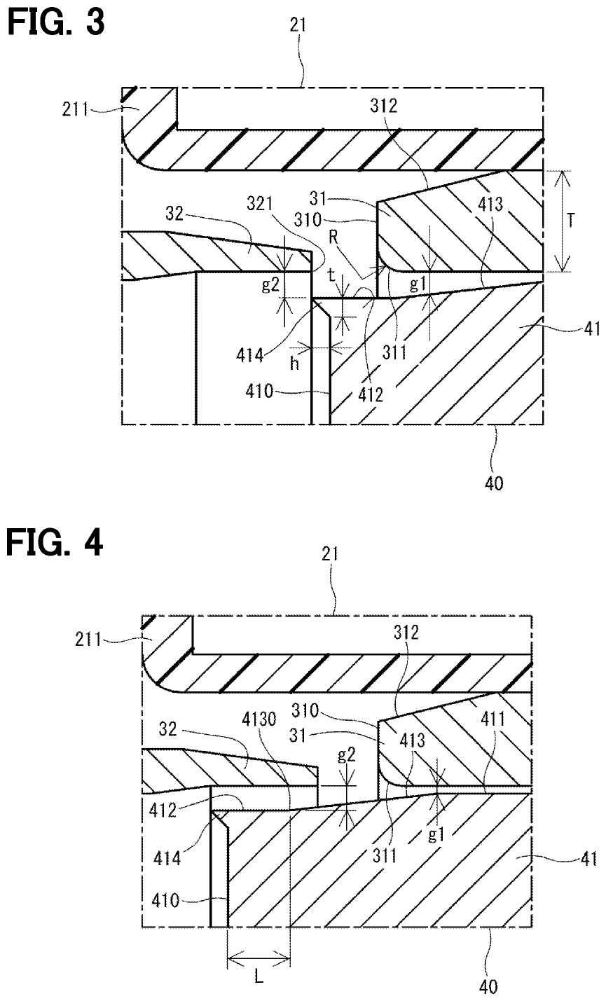

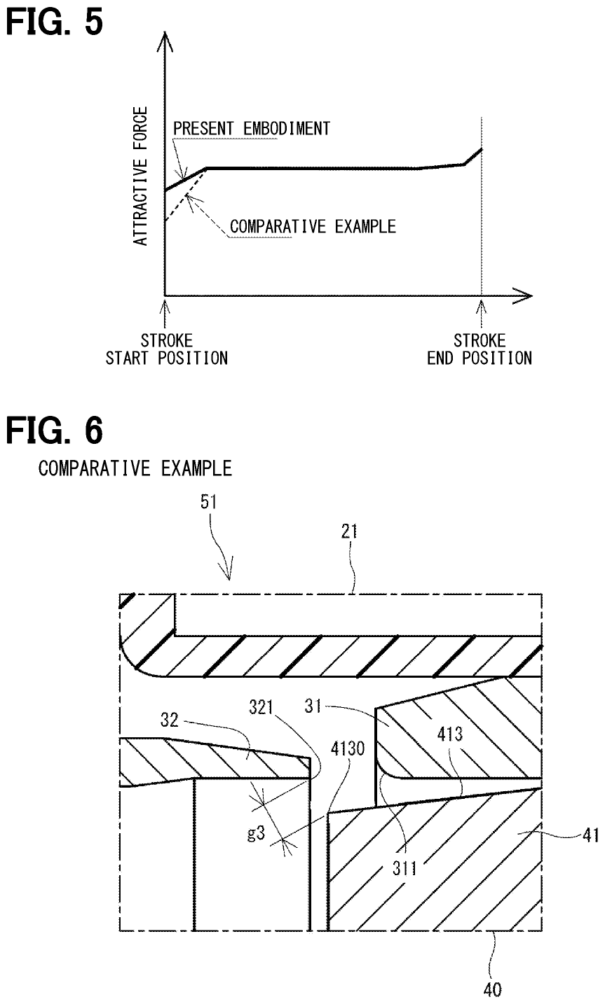

As shown in FIGS. 3 and 4, a large-diameter cylindrical portion 411 (see FIG. 4) is formed at a stroke start position side of the cylinder 41 of the mover 40, and a small-diameter cylindrical portion 412 is formed at a stroke end position side of the cylinder 41. Furthermore, a tapered portion 413 is formed between the large-diameter cylindrical portion 411 and the small-diameter cylindrical portion 412. The tapered portion 413 is formed such that a diameter of an outer peripheral surface of the tapered portion 413 is increased toward the stroke start position and is decreased toward the stroke end position. Then, when the mover 40 is moved toward the stroke end position, a width of a gap (g1) between the first stator 31 and the cylinder 41 of the mover 40 is changed by the tapered portion 413 such that an attractive force for attracting the cylinder 41 of the mover 40 during the stroke is substantially leveled, i.e., is flattened (see FIG. 5).

The small-diameter cylindrical portion 412 is a straight portion that has an outer wall, which extends in the axial direction and has a constant outer diameter along an entire axial extent thereof. The small-diameter cylindrical portion 412 extends continuously from the tapered portion 413 toward the second stator 32. An outer wall surface of the small-diameter cylindrical portion 412 is a cylindrical surface that has the outer diameter that is equal to an outer diameter of a smallest-diameter part 4130 (see FIG. 4) of the tapered portion 413 while the outer diameter of the smallest-diameter part 4130 is a smallest diameter at the tapered portion 413. The small-diameter cylindrical portion 412 keeps a substantially constant width of the gap (g2) between the cylinder 41 of the mover 40 and the second stator 32 in an axial range from the start to the end of the stroke. An axial length (L) of the small-diameter cylindrical portion 412 is preferably equal to or smaller than a stroke length of the mover 40. If the length of the small-diameter cylindrical portion 412 exceeds the stroke length, adjustment of the attractive force by the tapered portion 413 may possibly be adversely affected.

The cylinder 41 of the mover 40 has a projection 414 that has a triangular cross section and is formed at a front axial end surface 410 of the cylinder 41 (i.e., an end surface of the small-diameter cylindrical portion 412). The projection 414 projects from the end surface 410 of the small-diameter cylindrical portion 412 toward the stroke end position and circumferentially extends in a ring form along an entire circumference of the small-diameter cylindrical portion 412. As shown in FIG. 3, a thickness (t) of the projection 414, which is measured in a radial direction of the cylinder 41, is preferably about 0.05 mm to 1 mm. Furthermore, a projecting height (h) of the projection 414 is desirably equal to or smaller than one half of the stroke length of the mover 140.

As shown in FIGS. 1 and 2, in front of the projection 414, a recess 172 is recessed at an inner corner of the cover member 17 toward the stroke end position. The recess 172 is shaped in an annular form and has a depth that allows the projection 414 to enter the recess 172. The recess 172 is formed to avoid collision between the cover member 17 and the projection 414 at the stroke end position of the mover 40 in a case where the stroke of the mover 40 is extended from the position exemplified in FIG. 2 toward the cover member 17.

A curved surface 311 is formed at an inner periphery of the first stator 31 at an end portion of the first stator 31 which is located on the second stator 32 side and has an end surface 310. As shown in FIGS. 3 and 4, the curved surface 311 extends from the inner periphery of the first stator 31 toward an outer periphery of the first stator 31 so that the gap (g1) between the first stator 31 and the cylinder 41 of the mover 40 is increased by the curved surface 311. Furthermore, on an opposite side, which is radially opposite to the curved surface 311, a sloped surface 312 is formed at the outer periphery of the first stator 31 so that a wall thickness (indicated by reference sign T in FIG. 3) of the first stator 31 is reduced by the sloped surface 312 on the side where the second stator 32 is placed.

In FIG. 3, a radius (R) of curvature of the curved surface 311 is preferably equal to or more than 0.2 mm, and is preferably equal to or smaller than 90% of the wall thickness (T) of the first stator 31. More preferably, the radius (R) of curvature of the curved surface 311 is about 0.3 mm to 3 mm.

In the electromagnetic actuator 11 configured in the above-described manner, as shown in FIG. 3, when the mover 40 is in the stroke start position, the tapered portion 413 approaches, i.e., extends toward the second stator 32. However, since the small-diameter cylindrical portion 412, which is shaped in the straight form, is formed continuously on the second stator 32 side of the smallest-diameter part 4130 of the tapered portion 413, the gap (g2) between the cylinder 41 of the mover 40 and the second stator 32 will not be widened at or around the stroke start position. Therefore, the gap (g2) between the cylinder 41 and the second stator 32 can be made relatively narrow, and a decrease in the attractive force at a start initial period of the electromagnetic actuator 11 can be limited.

Furthermore, in the present embodiment, since the projection 414 further projects from the end surface 410 of the small-diameter cylindrical portion 412 toward the cover member 17, the gap (g2) can be made the narrowest at a corresponding position of the mover 40 where a position of a distal end of the projection 414 coincides with a position of the opening-end edge 321 of the second stator 32 in the axial direction, and this gap (g2) can be kept substantially constant from the stroke start position to the stroke end position of the mover 40 (see FIG. 4). Then, at or around the stroke end position of the mover 40, the curved surface 311 of the first stator 31 expands the gap (g1) and limits an increase in the attractive force. Therefore, with the electromagnetic actuator 11 of the first embodiment, as shown in FIG. 5, it is possible to obtain flat attraction characteristics over the entire length of the stroke.

Now, the influence of the straight portion (the small-diameter cylindrical portion 412) of the mover 40 on the attraction characteristics will be described with reference to a comparative example. FIG. 6 shows an electromagnetic actuator 51 of a comparative example. This electromagnetic actuator 51 has the curved surface 311 at the distal end of the first stator 31, and the cylinder 41 of the mover 40 has the tapered portion 413. However, the straight portion and the projection are not provided on the cover member 17 side of the tapered portion 413. Therefore, although the attractive force is substantially leveled by the tapered portion 413 in the middle of the stroke, the gap (g3) between the smallest-diameter part 4130 of the tapered portion 413 and the opening-end edge 321 of the second stator 32 is widened at or around the stroke start position. Therefore, in the case of the comparative example, as indicated by a dotted line in FIG. 5, the attractive force at the start time of the electromagnetic actuator is reduced, and the flat attraction characteristics cannot be obtained over the entire stroke length.

### Second Embodiment

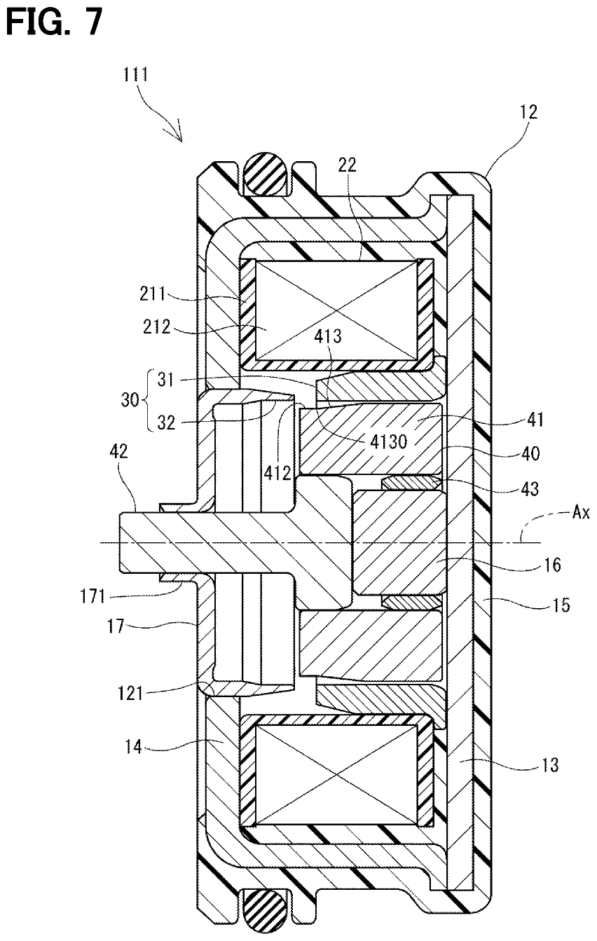

Next, a second embodiment of the present disclosure will be described with reference to FIG. 7. An electromagnetic actuator 111 of the second embodiment differs from the first embodiment with respect to that the curved surface 311 is not formed at the first stator 31, and the projection 414 is not formed at the cylinder 41 of the mover 40. However, in the electromagnetic actuator 111 of the second embodiment, like the first embodiment, the tapered portion 413 is formed at the cylinder 41, and the small-diameter cylindrical portion 412 is formed on the second stator 32 side of the smallest-diameter part 4130 of the tapered portion 413 in the cylinder 41. Therefore, the gap between the second stator 32 and the cylinder 41 of the mover 40 is narrowed at or around the stroke start position. Thus, the decrease in the attractive force at the start time of the electromagnetic actuator 111 is limited, and the flat attraction characteristics can be obtained over the entire stroke length.

### Other Embodiments

(1) In the above embodiments, as shown in FIGS. 1 and 2, the stator 30 is located on the inner side of the coil 21, and the mover 40 is located on the inner side of the stator 30. Alternatively, in another embodiment, the stator may be placed on the outer side of the coil, and the mover may be placed on the outer side of the stator, and the tapered portion and the straight portion may be formed at the mover.

(2) In the above embodiments, there is described the electromagnetic actuator 11, 111 used in the valve timing adjusting mechanism. However, the application of the electromagnetic actuator 11 is not particularly limited. In another embodiment, the electromagnetic actuator of the present disclosure may be applied to other types of devices or machines, which are other than the valve timing adjusting mechanism.

(3) In addition, the present disclosure is not limited to each of the above embodiments, and the shape and configuration of each part may be appropriately changed and implemented without departing from the spirit of the present disclosure.

What is claimed is:

1. An electromagnetic actuator comprising:
a coil;
a stator; and
a mover that is configured to be attracted and moved in an axial direction with a predetermined stroke by a magnetic force generated between the stator and the mover when the coil is energized, wherein:
the stator includes:
a first stator positioned at a side where a stroke start position of the mover is located; and
a second stator positioned at another side where a stroke end position of the mover is located;
the mover includes:
a tapered portion which has a diameter progressively reduced toward the second stator; and
a straight portion which extends continuously from the tapered portion toward the second stator; and
an outer wall of the straight portion, which extends in the axial direction, has an outer diameter that is substantially equal to an outer diameter of a smallest-diameter part of the tapered portion that has a smallest diameter at the tapered portion.

2. The electromagnetic actuator according to claim 1, wherein a length of the straight portion, which is measured in the axial direction, is equal to or smaller than a stroke length of the mover.
